(19) United States
(12) Patent Application Publication
(10) Pub. No.: US 2009/0280053 A1
(43) Pub. Date: Nov. 12, 2009

(54) Method For Producing Nanoparticles Of Aluminum Spinels, And The Use Thereof

(75) Inventor: Norbert Roesch, Gersthofen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT FINANCE (BVI) LIMITED, Tortola (VG)

(21) Appl. No.: 12/373,369

(22) PCT Filed: Jul. 7, 2007
(86) PCT No.: PCT/EP07/06036

§ 371 Date: Feb. 24, 2009

(30) Foreign Application Priority Data
Jul. 13, 2006 (DE) 10 2006 032 582.6
Jul. 7, 2007 (EP) PCT/EP2007/006036

(51) Int. Cl. C01G 51/04; C01F 7/04

(52) U.S. Cl. 423/594.5; 423/600

(57) ABSTRACT

The invention relates to a method for producing nanoparticles of aluminium spinels. According to said method, a salt of a metal, the oxide of which can form a spinel lattice with aluminium oxide, is added to an aqueous solution of aluminium chlorohydrate, the solution is then dried, and calcinated in less than 30 minutes, and the agglomerated material thus obtained is ground.

The present invention relates to the production of nanoparticles comprising aluminum spinels and their use.

Aluminum spinels occur naturally as minerals, and their production in nanocrystalline form and their use for many applications has already been described. The best-known representatives include zinc spinel ZnAl₂O₄, known as gahnite, and magnesium spinel MgAl₂O₄. The aluminum spinels as used as raw materials for ceramics (S. K. Sampath, J. F. Cordano, J. Am. Ceram. Soc. 81, 649 (1998)), as oxidation catalysts (T. Ohgushi, S. Umeno, Bull. Chem. Soc. Jpn. 60 (1987) 4457) and as pigments (E. DeBie, P. Doyen, Cobalt 15 (1962) 3). Zinc spinel also has a band gap and therefore displays interesting optical properties which qualify the material for electroluminescence applications (Hiroaki Matsui, Chao-Nan Xu, Yun Liu, Hiroshi Tateyama, Physical Review B 69, 235109 (2004)), as required in LEDs and displays.

The preparation of nanoparticulate zinc spinel has already been described in the literature (J. of Sol-Gel Science and Technology, 35, p. 221-224, 2005). A specific aluminum oxide Al(O¹OPr)₃ and Zn(NO₃)₂*6H₂O are used as precursors for the preparation and are calcined at temperatures in the range from 450° C. to 900° C. In “J. of Alloys and Compounds, 394 (2005), 255-258”, aluminum nitrate and zinc nitrate are used as starting materials with an addition of urea and this mixture is calcined at 350-450° C. A further synthetic route to aluminates of copper, manganese and zinc is described in “J. of Alloys and Compounds, 315 (2001), 123-128”. This route proceeds from metal acetates, aluminum nitrate and combustible substances such as hexamethyltetramine, urea, carbohydrazide and glycine. The mixtures are converted at 500° C. in a muffle furnace.

The disadvantages of the processes according to the known prior art are therefore that expensive starting compounds are used or the yields per unit time are low as a result of the processes. The known processes are therefore unsuitable for producing aluminum spinels on an industrial scale.

It is therefore an object of the present invention to provide a process for producing nanocrystalline aluminum spinels which gives high yields in a short time with minimal energy input. The product produced should be able to be redispersed by simple means and thus be able to give stable nanosuspensions. This object is achieved by the process described below, whose special feature is that a calcination time of less than 30 minutes is sufficient here.

The invention provides a process for producing nanoparticles of aluminum spinels, wherein an aqueous solution of aluminum chlorohydrate is admixed with a salt of a metal whose oxide is able to form a spinel lattice with aluminum oxide, the mixture is subsequently dried, calcined for less than 30 minutes and the agglomerates obtained in this way are comminuted.

The starting point for the process of the invention is aluminum chlorohydrate of the formula Al₂(OH)ₓCl_{y}, where x is from 2.5 to 5.5 and y is from 3.5 to 0.5 and the sum of x and y is always 6. Preference is given to using commercially available 50% strength aqueous solutions of aluminum chlorohydrate as starting material.

A salt of a metal which can form a spine lattice with aluminum oxide is added to this solution. Possible metal salts of this type are all divalent metal salts, for example the divalent salts of cobalt, zinc, manganese, copper, iron, magnesium, cadmium, nickel. Spinels have the empirical formula MAl₂O₄, where M is the divalent metal. This empirical formula automatically indicates the amount of metal salt which has to be added according to the invention to the solution of aluminum chlorohydrate. Since the spinel lattice can also contain defects, the amount of metal M or the amount of metal salt based on the Al₂O₃ matrix can also deviate from the stoichiometrically calculated value. In general, the amount of metal salt based on the Al₂O₃ matrix is from 30 to 80 mol %, preferably 50 mol %.

This solution is preferably additionally admixed with crystallization nuclei which promote the formation of the spinel lattice. In particular, such nuclei reduce the temperature for the formation of the spinel lattice in the subsequent thermal treatment. Possible nuclei are very finely divided spinels, for example zinc spinel, having an average particle size of less than 0.1 μm. In general, from 2 to 3% by weight of nuclei, based on the spinel formed, is sufficient.

This suspension of aluminum chlorohydrate and metal salt and, if appropriate, crystallization nuclei is then evaporated to dryness, e.g. by spray drying, freeze drying, granulation or by means of a roller dryer, and subjected to heat treatment (calcination). This calcination is carried out in apparatuses suitable for this purpose, for example in tunnel kilns, box furnaces, tube furnaces or microwave furnaces or a fluidized-bed reactor. Rotary tube furnaces which allow a high throughput at a short residence time are particularly useful. In one variant of the process of the invention, the aqueous suspension of aluminum chlorohydrate and metal salt can be sprayed directly into the calcination apparatus without prior removal of the water.

The temperature for the calcination should not exceed 1100° C. The lower temperature limit depends on the desired yield of aluminum spinel and the desired residual chlorine content. Spinel formation commences, depending on the type of spinel, at about 400° C., but to keep the chloride content low and the yield of spinel high, somewhat higher temperatures will be employed. In the case of zine spinel, the preferred temperature is, for example, about 850° C.

The calcination time is generally less than 30 minutes and can, depending on the type of spinel, be only a few minutes.

The calcination results in agglomerates of aluminum spinel in the form of virtually spherical primary crystallites, with the term “nano” referring to a particle size of generally from 1 to 100 nm. These agglomerates are deagglomerated in a subsequent step in which it is possible to use all deagglomeration methods known for ceramics, for example milling or introduction of ultrasonic energy, can be used since in the present case the agglomerates are soft and relatively easy to break up. The deagglomeration is preferably carried out at temperatures of from 20 to 100° C., particularly preferably from 20 to 90° C. Wet or dry milling is preferably employed for deagglomeration, with wet milling preferably being carried out in an attritor or stirred ball mill, while dry milling is carried out in an airjet mill. Since the nanoparticles sought as the product of milling are extremely reactive, additives which prevent reagglomeration of the nanoparticles are preferably added before or during milling. It is therefore particularly advantageous to carry out the subsequent deagglomeration in the form of wet milling. Vibration mills, attritor mills, ball mills, stirred ball mills or similar apparatuses are suitable for wet milling. The use of stirred ball mills has been found to be particularly advantageous. The milling time depends on the strength of the agglomerates and on the desired fineness and in the process of the invention is usually in the range from 2 to 6 hours. The wet milling or deagglomeration is advantageously carried out in an aqueous medium, but alcoholic or other organic solvents can also be used. Thus, for example, milling in water for 6 hours results in an aqueous suspension of nanocrystalline aluminum spinel having a d90 of about 30 nm. The suspension obtained after wet milling can be converted into a defined powder by spray drying, fluidized-bed drying, granulation or freeze drying.

A further possibility is to modify the surfaces of the nanospinel and thus obtain compatibility with organic solvents and coating compositions.

In the case of modification according to the invention of the surface of these nanoparticles with coating agents such as silanes or siloxanes, there are two possibilities. In the first preferred variant, the deagglomeration can be carried out in the presence of the coating agent, for example by adding the coating agent to the mill during milling. A second possibility is firstly to break up the agglomerates of the nanoparticles and subsequently treat the nanoparticles, preferably in the form of a suspension in a solvent, with the coating agent.

Possible solvents for the deagglomeration are, as mentioned above, both water and customary solvents, for example those which are also employed in the surface coatings industry, for example C₁-C₄-alcohols, in particular methanol, ethanol or isopropanol, acetone, tetrahydrofuran, butyl acetate. If the deagglomeration is carried out in water, an inorganic or organic acid, for example HCl, HNO₃, formic acid or acetic acid should be added in order to stabilize the resulting nanoparticles in the aqueous suspension. The amount of acid can be from 0.1 to 5% by weight, based on the mixed oxide. The particle fraction having a particle diameter of less than 20 nm is then preferably separated off from this aqueous suspension of the acid-modified nanoparticles by centrifugation. The coating agent, preferably a silane or siloxane, is subsequently added at elevated temperature, for example at about 100° C. The nanoparticles which have been treated in this way precipitate, are separated off and are dried to give a powder, for example by freeze drying.

Suitable coating agents here are preferably silanes or siloxanes or mixtures thereof.

Further suitable coating agents are all substances which can physically bind to the surface of the mixed oxides (adsorption) or can bind to the surface of the mixed oxide particles by formation of a chemical bond. Since the surface of the mixed oxide particles is hydrophilic and free hydroxy groups are available, possible coating agents are alcohols, compounds having amino, hydroxy, carbonyl, carboxyl or mercapto functions, silanes or siloxanes. Examples of such coating agents are polyvinyl alcohol, monocarboxylic, dicarboxylic and tricarboxylic acids, amino acids, amines, waxes, surfactants, hydroxycarboxylic acids, organosilanes and organosiloxanes.

Possible silanes or siloxanes are compounds of the formulae

a) R[—Si(R′R″)—O—]nSi(R′R″)—R″′ or cyclo-[—Si(R′R″)—O—]rSi(R′R″)—O—
where
R, R′, R″, R″′ are identical or different and are each an alkyl radical having 1-18 carbon atoms or a phenyl radical or an alkylphenyl or phenylalkyl radical having 6-18 carbon atoms or a radical of the general formula —(CmH2m-O)-CqH2q+1 or a radical of the general formula —CsH2sY or a radical of the general formula —XZt-1,
n is an integer in the range 1≦n≦1000, preferably 1≦n≦100,
m is an integer in the range 0≦m≦12 and
p is an integer in the range 0≦p≦60 and
q is an integer in the range 0≦q≦40 and
r is an integer in the range 2≦r≦10 and
s is an integer in the range 0≦s≦18 and
Y is a reactive group, for example an α,β-ethylenically unsaturated group such as a (meth)acryloyl, vinyl or allyl group, an amino, amido, ureido, hydroxyl, epoxy, isocyanato, mercapto, sulfonyl, phosphonyl, trialkoxylsilyl, alkyldialkoxysilyl, dialkylmonoalkoxysilyl, anydride or carboxyl group, an imido, imino, sulfite, sulfate, sulfonate, phosphine, phosphite, phosphate, phosphonate group and
X is a t-functional oligomer where
t is an integer in the range 2≦t≦8 and
Z is again a radical

R[—Si(R′R″)—O—]nSi(R′R″)—R′″ or cyclo-[-Si(R′R″)—O—]rSi(R′R″)—O—

as defined above.

The t-functional oligomer X is preferably an:

oligoether, oligoester, oligoamide, oligourethane, oligourea, oligoolefin, oligovinyl halide, oligovinylidene dihalide, oligoimine, oligovinyl alcohol, ester, acetal or ether of oligovinyl alcohol, cooligomer of maleic anhydride, oligomer of (meth)acrylic acid, oligomer of (meth)acrylic esters, oligomer of (meth)acrylamides, oligomer of (meth)acrylimides, oligomer of (meth)acrylonitrile, particularly preferably oligoether, oligoester, oligourethane.

Examples of radicals of oligoethers are compounds of the type —(CaH2a-O)b-CaH2a- or O-(CaH2a-O)b-CaH2a-O where 2≦a≦12 and 1≦b≦60, e.g. a diethylene glycol, triethylene glycol or tetraethylene glycol radical, a dipropylene glycol, tripropylene glycol, tetrapropylene glycol radical, a dibutylene glycol, tributylene glycol or tetrabutylene glycol radical. Examples of radicals of oligoesters are compounds of the type —CbH2b-(C(CO)CaH2a-(CO)O—CbH2b-)c- or —O—CbH2b—(C(CO)CaH2a-(CO)O—CbH2b-)c-O— where a and b are identical or different and are in the ranges 3≦a≦12, 3≦b≦12 and 1≦c≦30, e.g. an oligoester of hexanediol and adipic acid.

b) Organosilanes of the Type (RO)₃Si(CH₂)m-R′
R=alkyl such as methyl, ethyl, propyl
m=0.1-20
R′=methyl, phenyl
   —C4F9; OCF2—CHF—CF3, —C6F13, —O—CF2—CHF2
   —NH2, —N3, SCN, —CH═CH2, —NH—CH2—CH2—NH2,
   —N—(CH2—CH2—NH2)2
   —OOC(CH3)C═CH2
   —OCH2—CH(O)CH2
   —NH—CO—N—CO—(CH2)5
   —NH—COO—CH3, —NH—COO—CH2—CH3, —NH—(CH2)3Si(OR)3
   —Sx—(CH2)3)Si(OR)3
   —SH
   —NR′R″R″′(R′=alkyl, phenyl; R″=alkyl, phenyl; R″′=H, alkyl, phenyl, benzyl,
   C2H4NR″″ where R″″=A, alkyl and R″″′=H, alkyl).

Examples of silanes of the above-defined type are hexamethyldisiloxane, octamethyltrisiloxane, further homologous and isomeric compounds of the series

SinOn-1(CH3)2n+2, where

n is an integer in the range 2≦n≦1000, e.g. polydimethylsiloxane 200® fluid (20 cSt).

Hexamethylcyclotrisiloxane, octamethylcyclotetrasiloxane, further homologous and isomeric compounds of the series

(Si—O)r(CH3)2r, where

r is an integer in the range 3≦r≦12, dihydroxytetramethyldisiloxane, dihydroxyhexamethyltrisiloxane, dihydroxyoctamethyltetrasiloxane, further homologous and isomeric compounds of the series

HO—[(Si—O)n(CH3)2n]—Si(CH3)2—OH or

HO—[(Si—O)n(CH3)2n]—[Si—O)m(C6H5)2m]—Si(CH3)2—OH, where

m is an integer in the range 2≦m≦1000,
with preference being given to the α,ω-dihydroxypolysiloxanes, e.g. polydimethylsiloxane (OH end groups, 90-150 cST) or polydimethylsiloxane-co-diphenylsiloxane (dihydroxy end groups, 60 cST). Dihydrohexamethyltrisiloxane, dihydrooctamethyltetrasiloxane and further homologous and isomeric compounds of the series

H—[(Si—O)n(CH3)2n]—Si(CH3)2—H, where

n is an integer in the range 2≦n≦1000, with preference being given to the α,ω-dihydropolysiloxanes, e.g. polydimethylsiloxane (hydride end groups, Mn=580).

Di(hydroxypropyl)hexamethyltrisiloxane, di(hydroxypropyl)octamethyltetrasiloxane, further homologous and isomeric compounds of the series HO—(CH2)u[(Si—O)n(CH3)2(CH2)u-OH, with preference being given to the α,ω-dicarbinolpolysiloxanes in which 3≦u≦18, 3≦n≦1000 or their polyether-modified derivatives based on ethylene oxide (EO) and propylene oxide (PO) as homopolymers or copolymers HO-(EO/PO)v-(CH2)u[(Si—O)t(CH3)2t]—Si(CH3)2(CH2) u-(EO/PO)v-OH, with preference being given to α,ω-di(carbinolpolyether)polysiloxanes in which 3≦n≦1000, 3≦u≦18, 1≦v≦50.

Instead of α,ω-OH groups, it is likewise possible to use the corresponding bifunctional compounds bearing epoxy, isocyanato, vinyl, allyl and di(meth)acryloyl groups, e.g. polydimethylsiloxane having vinyl end groups (850-1150 cST) or TEGORAD 2500 from Tego Chemie Service.

Further possibilities are the esterification products of ethoxylated/propoxylated trisiloxanes and higher siloxanes with acrylic acid copolymers and/or maleic acid copolymers as modifying compound, e.g. BYK Silclean 3700 from Byk Chemie or TEGO® Protect 5001 from Tego Chemie Service GmbH.

Instead of α,ω-OH groups, it is likewise possible to use the corresponding bifunctional compounds bearing —NHR″″ where R″″=H or alkyl, e.g. the generally known aminosilicone oils from Wacker, Dow Corning, Bayer, Rhodia, etc., which bear (cyclo)alkylamino groups or (cyclo)alkylimino groups randomly distributed over their polysiloxane chain.

c) Organosilanes of the Type (RO)3Si(CnH2n+1) and (RO)3Si(CnH2n+1), where
R is alkyl such as methyl, ethyl, n-propyl, i-propyl, butyl
n is from 1 to 20.

Organosilanes of the type R′x(RO)ySi(CnH2n+1) and (RO)3Si(CnH2n+1), where
R is alkyl such as methyl, ethyl, n-propyl, i-propyl, butyl,
R′ is alkyl such as methyl, ethyl, n-propyl, i-propyl, butyl,
R′ is cycloalkyl
n is an integer in the range 1-20
x+y is 3
x is 1 or 2
y is 1 or 2

Organosilanes of the type (RO)3Si(CH2)m-R′, where
R is alkyl such as methyl, ethyl, propyl,
m is an integer in the range 0.1-20
R′ is methyl, phenyl, —C4F9; OCF2—CHF—CF3, —C6F13, —O—CF2—CHF2,
   —NH2, —N3,
   —SCN, —CH═CH2, —NH—CH2—CH2—NH2, —N—(CH2—CH2—NH2)2,
   —OOC(CH3)C═CH2,
   —OCH2—CH(O)CH2, —NH—CO—N—CO—(CH2)5, —NH—COO—CH3,
   —NH—COO—CH2—CH3,
   —NH—(CH2)3Si(OR)3, —Sx—(CH2)3)Si(OR)3, —SH—NR′R″R″′ (R′=alkyl, phenyl;
   R″=alkyl, phenyl; R″′=H, alkyl, phenyl, benzyl, C2H4NR″″R″″′ where
   R″″=H, alkyl and
   R″″′=H, alkyl).

Preferred silanes are the silanes listed below: triethoxysilane, octadecyltrimethoxysilane, 3-(trimethoxysilyl)propyl methacrylate, 3-(trimethoxysilyl)propyl acrylate, 3-(trimethoxysilyl)methyl methacrylate, 3-(trimethoxysilyl)methyl acrylate, 3-(trimethoxysilyl)ethyl methacrylate, 3-(trimethoxysilyl)ethyl acrylate, 3-(trimethoxysilyl)pentyl methacrylate, 3-(trimethoxysilyl)pentyl acrylate, 3-(trimethoxysilyl)hexyl methacrylate, 3-(trimethoxysilyl)hexyl acrylate, 3-(trimethoxysilyl)butyl methacrylate, 3-(trimethoxysilyl)butyl acrylate, 3-(trimethoxysilyl)heptyl methacrylate, 3-(trimethoxysilyl)heptyl acrylate, 3-(trimethoxysilyl)octyl methacrylate, 3-(trimethoxysilyl)octyl acrylate, methyltrimethoxysilane, methyltriethoxysilane, propyltrimethoxysilane, propyltriethoxysilane, isobutyltrimethoxysilane, isobutyltriethoxysilane, octyltrimethoxysilane, octyltriethoxysilane, hexadecyltrimethoxysilane, phenyltrimethoxysilane, phenyltriethoxysilane, tridecafluoro-1,1,2,2-tetrahydrooctyltriethoxysilane, tetramethoxysilane, tetraethoxysilane, oligomeric tetraethoxysilane (DYNASIL® 40 from Degussa), tetra-n-propoxysilane, 3-glycidyloxypropyltrimethoxysilane, 3-glycidyloxypropyltriethoxysilane, 3-methacryloxylpropyltrimethoxysilane, vinyltrimethoxysilane, vinyltriethoxysilane, 3-mercaptopropyltrimethoxysilane, 3-aminopropyltriethoxysilane, 3-aminopropyltrimethoxysilane, 2-aminoethyl-3-aminopropyltrimethoxysilane, triamino-functional propyltrimethoxysilane (DYNASYLAN® TRIAMINO from Degussa), N-(n-butyl-3-aminopropyltrimethoxysilane, 3-aminopropylmethyidiethoxysilane.

The coating agents, here especially the silanes or siloxanes, are preferably added in molar ratios of aluminum spinel nanoparticles to silane of from 1:1 to 10:1. The amount of solvent in the deagglomeration is generally from 50 to 90% by weight, based on the total amount of aluminum spinel nanoparticles and solvent.

The deagglomeration by milling and simultaneous modification with the coating agent is preferably carried out at temperatures of from 20 to 150° C., particularly preferably from 20 to 90° C.

If deagglomeration is carried out by milling, the suspension is subsequently separated off from the milling beads.

After deagglomeration, the suspension can be heated further for up to 30 hours to complete the reaction. The solvent is subsequently distilled off and the residue which remains is dried. It can also be advantageous to leave the modified aluminum spinel nanoparticles in the solvent and to employ the dispersion for further uses.

It is also possible to suspend the aluminum spinel nanoparticles in appropriate solvents and carry out the reaction with the coating agent after deagglomeration in a further step.

The aluminum spinels produced according to the invention can, as described at the outset, be used in a wide variety of ways. Zinc spinel is, owing to its band gap, suitable as UV absorber in coatings. In coating compositions, zinc spinel offers the advantage of UV absorption together with a simultaneous increase in scratch and abrasion resistance, due to the hardness of 8 on Moh's scale.

In addition, the nanostructured material can be used as catalyst material or as semiconducting material for light-emifting diodes and displays.

Cobalt spinel has been described as a pigment which is stable at high temperatures. The process of the invention enables nanosuspensions to be formulated simply and efficiently. Incorporation into binder systems and formulations can be effected without problems. Copper spinel in particular is, owing to the large active surface area and because of the copper ion, suitable as catalytically active material.

### EXAMPLES

### Example 1

A 50% strength aqueous solution of aluminum chlorohydrate was admixed with zinc chloride so that the ratio of aluminum oxide to zinc oxide after calcination is 50:50. After the solution had been homogenized by stirring, it was dried in a rotary evaporator. The solid aluminum chlorohydrate/zinc chloride mixture was comminuted in a mortar, resulting in a coarse powder.

The powder was calcined at 850° C. in a rotary tube furnace. The contact time in the hot zone was not more than 5 minutes. A white powder whose particle size distribution corresponded to the starting material was obtained.

X-ray structure analysis indicated that it is zinc spinel. The residual chlorine content is less than 100 ppm. The high-resolution scanning electron micrographs show crystals of <10 nm which are present in agglomerated form.

In a further step, 40 g of zinc spinel were suspended in 160 g of water. The suspension was deagglomerated in a vertical stirred ball mill from Netzsch (model PE 075). The milling beads used were composed of zirconium oxide (stabilized with yttrium) and had a size of 0.3 mm. The pH of the suspension was checked every 30 minutes and maintained at pH 4-4.5 by addition of dilute nitric acid. After 6 hours, the suspension was separated off from the milling beads and its particle size distribution was characterized by means of an analytical disk centrifuge from Brookhaven. A d90 of 55 nm was found.

### Example 2

A 50% strength aqueous solution of aluminum chlorohydrate was admixed with cobalt(II) chloride so that the ratio of aluminum oxide to cobalt oxide after calcination is 50:50. After the solution had been homogenized by stirring, it was dried in a rotary evaporator. The solid aluminum chlorohydrate/cobalt(II) chloride mixture was comminuted in a mortar, resulting in a coarse powder.

The powder was calcined at 1000° C. in a rotary tube furnace. The contact time in the hot zone was not more than 5 minutes. A deep blue powder whose particle size distribution corresponded to the starting material was obtained. X-ray structure analysis indicated that a spinel lattice is present.

In a further step, 40 g of cobalt spinel were suspended in 160 g of water. The suspension was deagglomerated in a vertical stirred ball mill from Netzsch (model PE 075). The milling beads used were composed of zirconium oxide (stabilized with yttrium) and had a size of 0.3 mm. The pH of the suspension was checked every 30 minutes and maintained at pH 4-4.5 by addition of dilute nitric acid. After 6 hours, the suspension was separated off from the milling beads and its particle size distribution was characterized by means of an analytical disk centrifuge from Brookhaven. A d90 of 60 nm, a d50 of 34 nm and a d10 of 15 nm were found.

1. A process for producing nanoparticles of aluminum spinels, comprising the steps of: admixing an aqueous solution of aluminum chlorohydrate with a salt of a metal whose oxide is able to form a spinel lattice with aluminum oxide, subsequently drying the mixture, calcining the dried mixture for less than 30 minutes and comminuting the agglomerates obtained.

2. The process as claimed in claim 1, wherein the aluminum chlorohydrate is a compound of the chemical formula Al₂(OH)ₓ)Cl_{y}, where x is from 2.5 to 5.5 and y is from 3.5 to 0.5 and the sum x+y is always 6.

3. The process as claimed in claim 1, wherein the salt of cobalt, zinc, manganese, copper, iron, magnesium, cadmium or nickel is used as metal salt for the formation of the spinel lattice.

4. The process as claimed in claim 1, wherein from 30 to 80% by weight of metal salt, based on the weight of Al₂O₃ matrix, is used.

5. The process as claimed in claim 1, wherein the calcining step is carried out at temperatures below 1100° C.

6. A process for producing nanoparticles of aluminum spinels, comprising the steps of: admixing an aqueous suspension of aluminum chlorohydrate with a salt of a metal whose oxide is able to form a spinel lattice with aluminum oxide, subsequently spraying the admixed suspension directly into a calcining apparatus without prior removal of the water, calcining for less than 30 minutes and comminuting the agglomerates obtained.

7. The process as claimed in claim 1, wherein the agglomerates formed during the calcining step are broken up by wet or dry milling in a subsequent step.

8. The process as claimed in claim 1, wherein the agglomerates formed during the calcining step are broken up by wet milling in a subsequent step, with acrylates, polyvinyl alcohols, polyethylene glycols, stearates or wax emulsions being added to the suspension during or after wet milling.

9. The process as claimed in claim 1, wherein the agglomerates formed during the calcining step are broken up by wet milling in a subsequent step and the suspension obtained is subjected to spray drying, freeze drying or granulation.

10. The process as claimed in claim 1, wherein the agglomerates are comminuted and the surface of the nanopigments is at the same time altered by means of modifying agents, preferably by means of a silane or siloxane at the surface.

11. The process as claimed in claim 1, wherein the agglomerates are comminuted by milling in stirred ball mills.

12. The process as claimed in claim 1, wherein the agglomerates are comminuted by milling or by action of ultrasound at from 20 to 90° C.

13. The process as claimed in claim 1, wherein the is carried out in a C₁-C₄-alcohol as solvent.

14. The process as claimed in clam 1, wherein the comminuting is carried out in acetone, tetrahydrofuran, butyl acetate and other solvents used in the surface coatings industry.

15. The process as claimed in claim 10, wherein the molar ratio of nanoparticles to coating agent is from 1:1 to 10:1.
